(19) United States
(12) Patent Application Publication
(10) Pub. No.: US 2009/0285346 A1
(43) Pub. Date: Nov. 19, 2009

(54) APPARATUS FOR ASSISTING THE LOADING OR UNLOADING OF A CORE IN A PRESSURIZED-WATER REACTOR

(75) Inventors: Robert Staudigel, Hochstadt (DE); Jürgen Sommer, Neckarwestheim (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/475,952

(22) Filed: Jun. 1, 2009

Related U.S. Application Data
(63) Continuation of application No. PCT/EP2007/010108, filed on Nov. 22, 2007.

(30) Foreign Application Priority Data
Nov. 30, 2006 (DE) 10 2006 057 077.4
Feb. 13, 2007 (DE) 10 2007 006 969.5

(51) Int. Cl. G21C 19/16

(52) U.S. Cl. 376/264

(57) ABSTRACT

An apparatus for loading and unloading a core of a pressurized water reactor exerts a force acting transversely to an axial direction of a fuel assembly against an upper region of a fuel assembly adjacent a fuel assembly unloading or loading position of the core. The apparatus is an immersion vehicle being freely maneuverable under water and on which an extendable carrier arm is disposed and at least indirectly positioned against the fuel assembly.

### CROSS-REFERENCE TO RELATED APPLICATION

This is a continuing application, under 35 U.S.C. § 120, of copending International Application No. PCT/EP2007/010108, filed Nov. 22, 2007, which designated the United States; this application also claims the priority, under 35 U.S.C. § 119, of German Patent Application 10 2006 057 077.4, filed Nov. 30, 2006 and German Patent Application 10 2007 006 969.5, filed Feb. 13, 2007; the prior applications are herewith incorporated by reference in their entirety.

### BACKGROUND OF THE INVENTION

### Field of the Invention

The invention relates to an apparatus for assisting the loading or unloading of a core in a pressurized-water reactor.

So-called fuel assembly loading machines are used for loading and unloading a core in a pressurized-water reactor. The fuel assembly loading machines are moved precisely to the respective fuel assembly position and must be aligned there and centered with respect to the fuel assembly.

It is known from numerous inspection results that the fuel assemblies in a pressurized-water reactor deform or contort plastically, i.e. permanently, over their period of use as a function of their position in the core. Bending can have various causes, for example anisotropy in thermal expansion or a growth, induced by radioactive radiation, in the length of fuel rod cladding tubes or control rod guide tubes. Presumably, the main reasons for the bending are, however, primarily an interaction between the flowing cooling water and the fuel assembly as well as inhomogeneities during the inflow and outflow of the cooling water into or out of the core.

Deformed or contorted fuel assemblies cause problems during the centering of the fuel assembly loading machine. In fuel assembly loading machines which are typical nowadays, centering pins of a centering dome or bell of the fuel assembly loading machine are inserted into centering holes of the adjacent fuel assemblies in order to center the fuel assembly loading machine. If the fuel assemblies are offset or contorted, the fuel assembly loading machine cannot be centered. Moreover, the bending can reach such an extent that a replacement of the fuel assemblies during loading or unloading of the core becomes impossible, since severely bent fuel assemblies can no longer be readily pulled out of the core and loaded into the core.

German Published, Prosecuted Patent Application DE 1 614 459 B discloses a fuel assembly loading machine which has a tubular centering device at its lower end. The centering device has a conical shape at its lower edge and glides along the fuel assemblies which are adjacent the fuel assembly loading or unloading position, pushes those fuel assemblies apart and is thus positioned exactly centrally in the fuel assembly. Reliable centering is possible using that known fuel assembly loading machine only if fuel assemblies surrounding the fuel assembly position are disposed symmetrically around that position.

### SUMMARY OF THE INVENTION

It is accordingly an object of the invention to provide an apparatus for assisting the loading and unloading of a core in a pressurized-water reactor, which overcomes the hereinafore-mentioned disadvantages of the heretofore-known apparatuses of this general type and which is used to facilitate the replacement of a fuel assembly.

With the foregoing and other objects in view there is provided, in accordance with the invention, an apparatus for assisting the loading or unloading of a core in a pressurized-water reactor. The apparatus comprises an immersion vehicle being freely maneuverable under water and at least one extendable carrying arm disposed on the immersion vehicle and configured to be positioned at least indirectly against an upper region of a fuel assembly adjacent a fuel assembly loading or unloading position in the core, while exerting a force acting transversely to an axial direction of the fuel assembly.

Through the use of this apparatus, the fuel assembly is either pushed or bent away from the fuel assembly loading or unloading position, or is pulled closer to the fuel assembly position. However, it is generally necessary to bend the fuel assembly away using a force which is directed away from the fuel assembly position, with the result that a larger clear space is produced which makes it possible to remove a bent fuel assembly from that position or to place it into that position, or to insert a fuel assembly without deformation into a fuel assembly position which is surrounded by deformed fuel assemblies. Additionally, due to the use of an immersion vehicle, the complicated installation of a manipulator is dispensed with, and any obstruction during use of the fuel assembly loading machine is largely avoided.

The term “at least indirectly” within the context of the present invention means that the carrying arm either acts directly (during the act of pushing away) or acts indirectly on the adjacent fuel assembly if the arm is positioned against a fuel assembly which is adjacent the fuel assembly and through which the force is transferred to the adjacent fuel assembly.

In accordance with another feature of the invention, the extendable carrying arm includes, at its free end, a journal, which can be inserted into a head frame of the fuel assembly from above and which, during the act of extending or retracting the carrying arm, bears against an inner surface of the head frame while exerting the force. In this way, in particular, the act of pushing away a fuel assembly which is bent towards the fuel assembly position which is being loaded or unloaded is facilitated, since it is readily possible, even in the case of fuel assemblies which adjoin each other closely, to insert the mandrel into the head frame.

In accordance with a further feature of the invention, the immersion vehicle includes at least one support element for absorbing the force exerted by the carrying arm onto the fuel assembly. In this manner, reliable anchoring of the immersion vehicle and thus efficient transfer of force onto the fuel assembly are ensured.

In accordance with an added feature of the invention, at least two extendable carrying arms are provided which exert opposing forces onto fuel assemblies which are located mutually opposite the neighboring positions to the fuel assembly position. In this way, the resulting force exerted onto the immersion vehicle as the two carrying arms are extended is significantly reduced.

In accordance with an additional feature of the invention, the at least one support element is preferably formed by a mandrel which can be inserted into a centering hole in the head frame of a fuel assembly and is vertical in the mounted state of the fuel assembly, that is to say extends in a longitudinal direction of the fuel assembly. The fuel assembly is adjacent the fuel assembly position and the fuel assembly against which the carrying arm or arms can be positioned. This enables a fixing of the immersion vehicle largely without play.

In accordance with a concomitant feature of the invention, the immersion vehicle has a U-shaped buoyancy body. It is thus possible to shift the center of the buoyancy force to the vicinity of the center of the immersion vehicle without obstructing the approaching movement of the fuel assembly loading machine, since the latter can then be moved downward into the fuel assembly position between the legs of the buoyancy body.

Other features which are considered as characteristic for the invention are set forth in the appended claims.

Although the invention is illustrated and described herein as embodied in an apparatus for assisting the loading or unloading of a core in a pressurized-water reactor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an apparatus according to the invention; and

FIG. 2 is an enlarged, fragmentary, perspective view of a portion of the apparatus, in a work position.

### DETAILED DESCRIPTION OF THE INVENTION

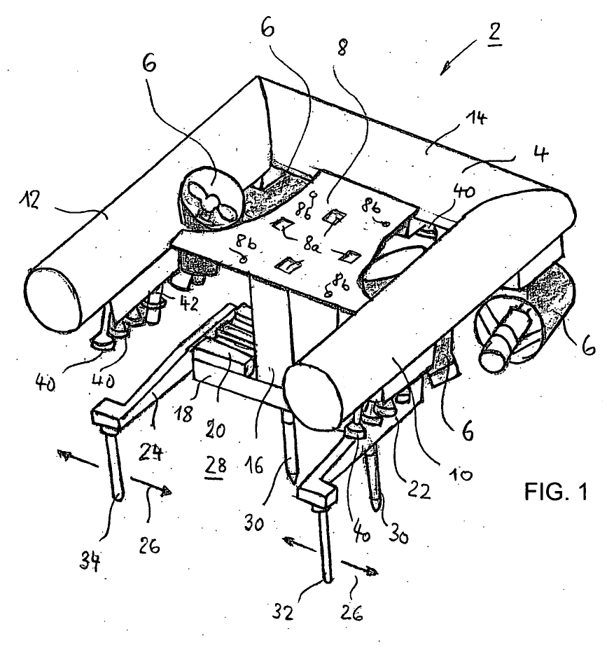

Referring now to the figures of the drawings in detail and first, particularly, to FIG. 1 thereof, there is seen an immersion vehicle 2, which is provided as an apparatus that can maneuver freely under water. The immersion vehicle 2 includes a U-shaped buoyancy body 4, the buoyancy of which under water at least approximately compensates for the weight of the immersion vehicle 2. Disposed on the immersion vehicle 2 are a number of drive units 6 which can be used to freely position the immersion vehicle 2 under water with respect to its location and with respect to its spatial alignment. In this case, other components of the immersion vehicle 2 and the U-shaped buoyancy body 4 are configured and disposed in such a way that a plane defined by legs 10, 12 and a base 14 of the U-shaped buoyancy body 4 is oriented at least approximately horizontally if the immersion vehicle 2 is in the floating state, with the drive units 6 switched off, so that only minor corrections, if at all, are necessary for an exact horizontal alignment. Those corrections are carried out by driving the drive units 6. In other words, the center of the displaced volume and the center of mass are located on a straight line which extends perpendicularly to the plane defined by the buoyancy body 4.

A gripper or support plate 8, which connects the two legs 10, 12 to each other and to the base 14, is mounted on the buoyancy body 4. Starting from the support plate 8, a column 16 extends perpendicularly with respect to the plane defined by the U-shaped buoyancy body 4, with a carrier plate 18 being disposed at that end of the column 16 which faces away from the support plate 8. The center of mass of the immersion vehicle 2 is outside the plane defined by the U-shaped buoyancy body 4 on the side which faces the carrier plate 18. As a result, in a resting state, i.e. in the stable floating state (buoyancy force≈gravity), the center of mass is located beneath the buoyancy body 4. Hydraulic cylinders 20 are disposed on the carrier plate 18 on both sides of the column 16, with only those hydraulic cylinders 20 which are located on one side of the column 16 being visible in the perspective illustration of FIG. 1. A carrying arm 22, 24 is fixed at a free end of pistons of each respective hydraulic cylinder 20. The carrying arms 22, 24 can be extended or retracted linearly, through the use of the hydraulic cylinders 20, in the direction of double arrows 26, perpendicularly with respect to the longitudinal axis of the column 16 and parallel to the base 14 or to the plane defined by the U-shaped buoyancy body 4.

The carrying arms 22, 24 extend parallel to the legs 10, 12 of the buoyancy body 4, i.e. transversely with respect to the extension direction, and project beyond the carrier plate 18 in such a way that the end face of the carrier plate 18, which faces the free end of the carrying arms 22, 24, defines a fixture-free gap 28 which is U-shaped in cross section. The fixture-free gap 28 extends over the entire structural height of the immersion vehicle 2, that is to say over its extent perpendicularly with respect to the plane defined by the U-shaped buoyancy body 4.

Two support elements or mandrels 30, which are fixed on the underside of the carrier plate 18, which is located opposite the buoyancy body 4, extend parallel to the column 16 or perpendicularly with respect to the plane defined by the buoyancy body 4.

One pin or journal 32, 34 is situated at the free end of each respective carrying arm 22, 24. The journals 32, 34 extend in the same direction as the mandrels 30 and point away from the buoyancy body 4.

In order to enable correct positioning and alignment of the immersion body 2, a large number of light sources 40 and a plurality of submersible cameras 42 are additionally disposed at the buoyancy body 4.

The support plate 8 additionally contains a plurality of openings 8a,b which are used to dock and center a single gripper of a fuel assembly loading machine should it become necessary to salvage the immersion vehicle 2 due to electronics failure or a failure of individual aggregates.

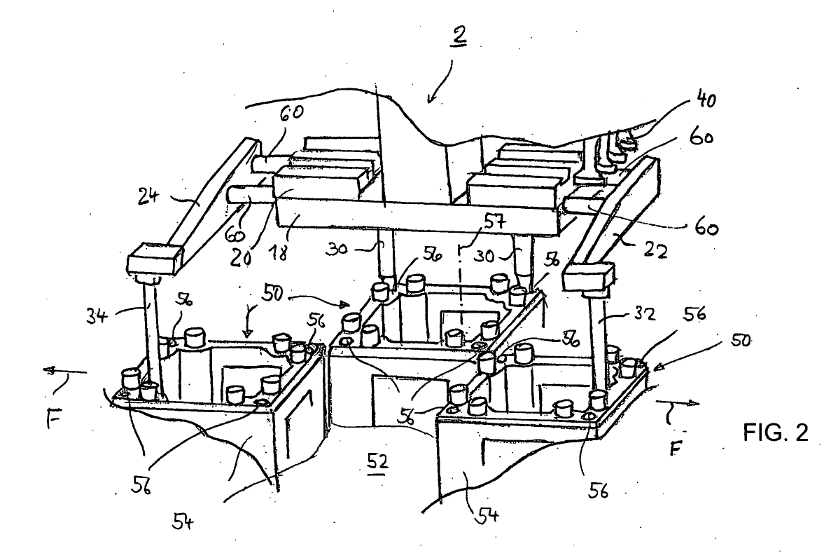

In FIG. 2, a portion of the immersion vehicle 2 is illustrated in a work position over a core of a pressurized-water reactor, of which only an upper region for three fuel assemblies 50 is illustrated. The fuel assemblies 50 surround a fuel assembly position 52 which is empty in the exemplary embodiment. Only head or top frames 54 of the fuel assemblies 50 are visible in the figure. Each corner of upper end faces of the head frames 54 has a respective centering hole 56. The mandrels 30 are inserted into the centering holes 56 in the work position of the immersion vehicle 2 and fix the immersion vehicle in this manner transversely with respect to an axial direction 57 of the fuel assemblies 50. To this end, the mandrels 30 have a beveled insertion face and are mounted on the carrier plate 18 at a spacing which corresponds to the distance between two centering holes 56.

In the work position, the carrying arms 22, 24, which are each fixed to two respective pistons 60, are extended in such a way that the journals 32, 34 project into the interiors of the fuel assemblies 50 and each bear against an inner surface of one of the head frames 54, i.e. in an upper region of the fuel assemblies 50. In the illustrated embodiment, the journals 32, 34 project into the interiors formed by the head frames 54 which are situated in the positions adjacent the fuel assembly position 52 and opposite each other. By extending the pistons 60, a force F is thus exerted, in each case in the direction of the arrows, onto the fuel assemblies 50 which are disposed on both sides of the fuel assembly position 52, in such a way that they are situated opposite each other, with the force F pushing the fuel assemblies 50 away from each other such that the distance between the two fuel assemblies 50 increases. This increase in distance reaches a maximum in the region of the head frames 54.

The free gap 28 seen in FIG. 1 is situated between the carrying arms 22, 24 and ensures that the fuel assembly position 52 is freely accessible from above, with the result that the fuel assembly position 52 can be loaded and unloaded without difficulty.

The forces F exerted onto the two opposite fuel assemblies 50 are directed in mutually opposing directions and are at least approximately of the same magnitude, with the result that the force to be absorbed by the fuel assembly 50, into which the mandrels 30 are inserted, disappears at least approximately, in order to ensure that only the two mutually opposite fuel assemblies 50 are pushed away from each other. The mandrels 30 inserted into the central fuel assembly 50 serve as additional support elements which absorb the net force exerted onto the carrying arms 22, 24, if the forces F are not of the same magnitude.

The directions in which the forces F are exerted, that is to say in which the available gap is to be increased, depend during unloading on how the bending, which is typically C-arc-shaped, of a fuel assembly 50 which is located in that fuel assembly position 52, is to be orientated. Alternatively, in the case of loading, the forces F depend on the orientation with which a used bent fuel assembly 50 is to be inserted into the fuel assembly position 52.

Instead of the hydraulic linear adjustment of the journals 32, 34, as illustrated in the figures, a hydraulically driven pivot movement, or a pivot movement which is driven by an electro-motor, can also be provided. If the pivot movement is driven by an electro-motor, there is no need to carry hydraulic lines. Additionally, an emergency release is provided which releases additional bearing play in the pivot bearing if the journals 32, 34 are jammed, with the result that the journals 32, 34 can be lifted out of the centering holes 56.

In principle, it may also be necessary in rare cases to move the two opposite fuel assemblies 50 toward each other with a force which is directed toward the empty fuel assembly position 52 in order to enable the insertion of a fuel assembly centering dome or bell into the centering holes 56. In this case, the journals 32, 34 can be moved, for example, into the head frames 54 of the fuel assemblies which are adjacent the fuel assemblies 50 and can be positioned in the direction of the empty fuel assembly position 52.

1. An apparatus for assisting the loading or unloading of a core in a pressurized-water reactor, the apparatus comprising:
an immersion vehicle being freely maneuverable under water; and
at least one extendable carrying arm disposed on said immersion vehicle and configured to be positioned at least indirectly against an upper region of a fuel assembly adjacent a fuel assembly loading or unloading position in the core, while exerting a force acting transversely to an axial direction of the fuel assembly.

2. The apparatus according to claim 1, wherein said at least one carrying arm has a free end and a journal at said free end configured to be inserted into a head frame of the fuel assembly from above and to bear against an inner surface of the head frame while exerting the force during extension or retraction of said at least one carrying arm.

3. The apparatus according to claim 1, wherein said immersion vehicle includes at least one support element for absorbing the force exerted by said at least one carrying arm onto the fuel assembly.

4. The apparatus according to claim 1, wherein said at least one extendable carrying arm is at least two extendable carrying arms exerting opposing forces onto fuel assemblies located in mutually opposite positions neighboring the fuel assembly loading or unloading position.

5. The apparatus according to claim 3, wherein said at least one support element is a mandrel configured to be inserted into a vertical centering hole in the head frame of a fuel assembly adjacent the fuel assembly loading or unloading position and adjacent the fuel assembly against which said at least one carrying arm can be positioned.

6. The apparatus according to claim 4, wherein said at least one support element is a mandrel configured to be inserted into a vertical centering hole in the head frame of a fuel assembly adjacent the fuel assembly loading or unloading position and adjacent the fuel assemblies against which said at least two carrying arms can be positioned.

7. The apparatus according to claim 1, wherein said immersion vehicle has a U-shaped buoyancy body.
